(19) United States
(12) Patent Application Publication
(10) Pub. No.: US 2009/0188619 A1
(43) Pub. Date: Jul. 30, 2009

(54) METHOD OF MAKING MOUSE PAD

(76) Inventor: Semi KAO, Huatan Township (TW)

Correspondence Address: SINORICA, LLC, 2275 Research Blvd., Suite 500, ROCKVILLE, MD, 20850, US

(21) Appl. No.: 12/021,749

(22) Filed: Jan. 29, 2008

(51) Int. Cl. B29C 65/00

(52) U.S. Cl. 156/277

(57) ABSTRACT

The present invention provides a method of making a mouse pad, which mainly includes heating and pressing a fiber fabric on a surface of the mouse pad to form the fiber fabric with a flat layer and a fiber layer, and then printing pattern on the flat layer of the fiber fabric to get the mouse pad with a clear pattern.

### BACKGROUND OF THE INVENTION

1. Field of the Invention

The present invention relates generally to a pad, and more particularly to a method of making a mouse pad.

2. Description of the Related Art

Conventional mouse pads are classified into tow types, named hard mouse pad and soft mouse pad. The hard mouse pad has a plastic layer, PP, PVC, and PC for example, and a skidproof layer, NR, EVA, and PU for example. The soft mouse pad has a fabric layer, polyester and cotton for example, and a skidproof layer, NR, EVA, and PU for example. Besides, to have an attractive look, both of the hard mouse pad and soft mouse pad are printed with patterns or words on the plastic layer or on fabric layer.

Because of the plastic layer having smoother surface, the pattern printed thereon is clearer and dirt or dust thereon is easier to clean. The hard mouse pad, however, is harder that is hard to fold and carry. The soft mouse pad is softer to be rolled up and has well shock absorption. But, the fabric layer is easier to get stain thereon, unclear pattern, threads on the edges, and an unattractive look. In other words, both of hard mouse pad and soft mouse pad have their own advantages and disadvantages, and the disadvantages may be improved.

### SUMMARY OF THE INVENTION

The primary objective of the present invention is to provide method of making a mouse pad, which the mouse pad has the advantages of both of the conventional hard and soft mouse pads.

According to the objectives of the present invention, a method of making a pad, comprising the steps of preparing a fiber fabric; heating and pressing the fiber fabric on a side thereof to form the fiber fabric with a flat layer and a fiber layer; printing a pattern on the flat layer of the fiber fabric; and bonding an elastic member to the fiber layer of the fiber fabric to form a mouse pad.

The present invention further provides another method, which includes preparing an unprinted mouse pad material including an elastic member and a fiber fabric attached on the elastic member; heating and pressing the fiber fabric of the mouse pad material to form the fiber fabric with a flat layer and a fiber layer; and printing a pattern on the flat layer of the fiber fabric.

### BRIEF DESCRIPTION OF THE DRAWINGS

FIG. 1 is a flow chart of a first preferred embodiment of the present invention;

FIG. 2 is a perspective view of the mouse pad made by the method of the first preferred embodiment of the present invention;

FIG. 3 is a lateral view of the mouse pad made by the method of the first preferred embodiment of the present invention;

FIG. 4 is a sketch diagram of the heating and pressing step of the first preferred embodiment of the present invention;

FIG. 5 is a sketch diagram of the heating and pressing step of a second preferred embodiment of the present invention;

FIG. 6 is a sketch diagram of the heating and pressing step of a third preferred embodiment of the present invention; and

FIG. 7 is a sketch diagram of the heating and pressing step of a fourth preferred embodiment of the present invention.

### DETAILED DESCRIPTION OF THE INVENTION

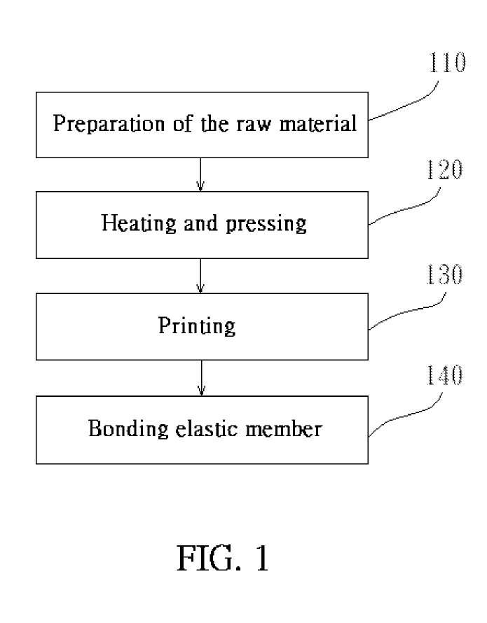

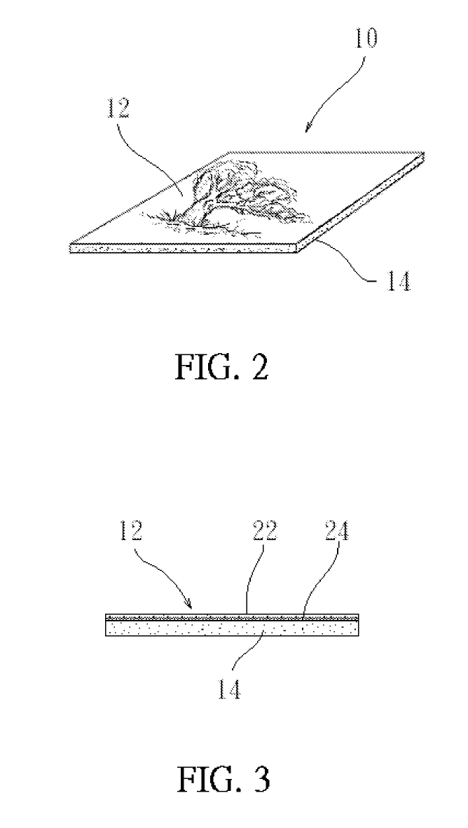

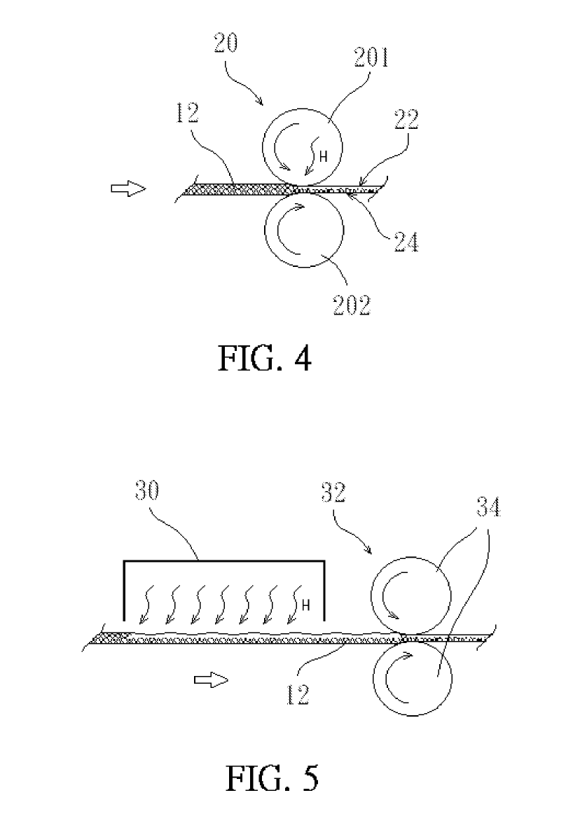

As shown in FIGS. 1 to 4, a method of making a mouse pad 10 of the first preferred embodiment of the present invention includes the steps of:

The first step is preparation of raw material 110, which the raw material includes a fiber fabric 12 with a fiber structure, such as polyester, cotton, and the like.

The second step is heating and pressing 120, which uses a conventional rolling apparatus 20 to heat and press the fiber fabric 12 simultaneously. The rolling apparatus 20 includes a heating roller 201 and a room temperature roller 202. A temperature of the heating roller 201 is greater than or at least equal to a melting temperature of the fiber fabric 12. The fiber fabric 12 passes the heating roller 201 and the room temperature roller 202 and is heated and pressed to melt parts of the fibers on a surface of the fiber fabric 12, and the molten fibers are pressed to form a very thin flat layer 22 and a fiber layer 23 under the flat layer 22. The flat layer 22 makes the fiber fabric 12 having a plastic like smooth surface.

The third step of the present invention is printing 130 to print pattern or word on the flat layer 22.

The fourth step of the present invention is bonding elastic member 140. The fiber layer 23 of the fiber fabric 12 is attached on an elastic member 14 to form a mouse pad 20 with a clear pattern on the surface. The elastic member 14 may be made of rubber. The ways of attaching the fiber fabric 12 on the elastic member 14 includes using glue or putting the fiber fabric 12 on an unfoamed rubber sheet (with foaming agent therein already), and then performing vulcanization procedure to bond them together.

The present invention provides the fiber fabric 12 of the mouse pad 20 being heated and pressed to form a thin flat layer 22 on the surface. As has described previously, the flat layer 22 has a plastic like flat surface that it may print clear pattern thereon and clean the stain thereon easily. Besides, there is no thread left on the edge. The flat layer 22 is very thin that the mouse pad 20 may be rolled up to carry. The elastic member 14 provides the shock absorbing function. In conclusion, the mouse pad made by the method of the present invention has the advantages of both of the conventional hard and soft mouse pads but the disadvantage thereof.

As shown in FIG. 5, the heating the pressing step may use a conventional oven 30 to heat the fiber fabric 12 first, and then send the fiber fabric 12 to a rolling apparatus 32 including two room temperature rollers 34.

It may use a conventional hot press apparatus (not shown) in the heating the pressing step of the present invention. The hot press apparatus includes a base and a movable hot pressing plate. The fiber fabric 12 is put on the base, and the hot pressing plate is preheated and moves down to heat and press the fiber fabric 12 in the same time.

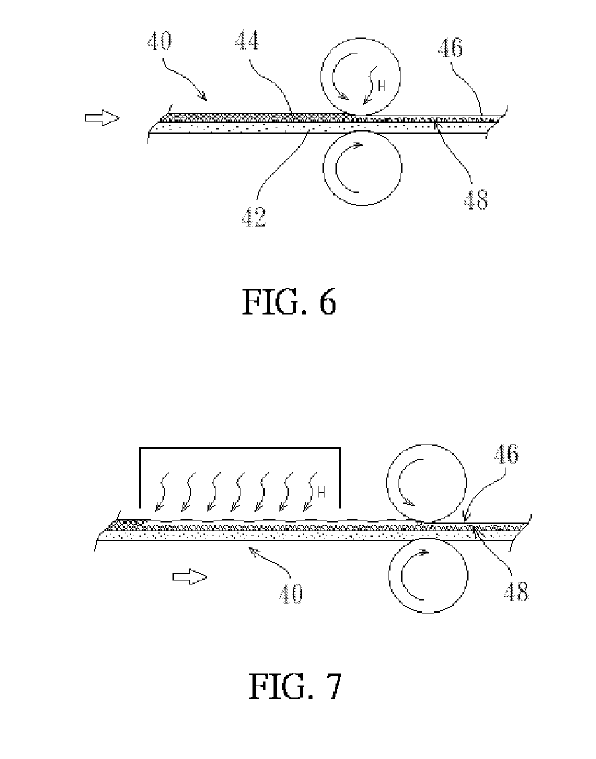

As shown in FIG. 6 and FIG. 7, in the preparation of raw material step, it may prepare an unprinted mouse pad material 40, which includes an elastic member 42 and a fiber fabric 44 (they have been bonded together already). Aforesaid rolling apparatus (with the heating roller) or the oven and the rolling apparatus (without the heating roller) may be incorporated in the present process to form the fiber fabric 44 with a flat layer 46 and a fiber layer 48. It may print clear pattern on the flat layer 46 to form the same mouse pad as described above.

The rolling apparatus may have texture thereon to press the mouse pad with 3-dimension pattern that may provide the mouse pad with more attractive look.

In conclusion, the method of the present invention may make the mouse pad with properties of soft, rolling up, and shock absorption to have all the advantages of the conventional mouse pads but the disadvantage thereof.

The description above is a few preferred embodiments of the present invention and the equivalence of the present invention is still in the scope of the claim of the present invention.

What is claimed is:

1. A method of making a pad, comprising the steps of:
preparing a fiber fabric;
heating and pressing the fiber fabric on a side thereof to form the fiber fabric with a flat layer and a fiber layer;
printing a pattern on the flat layer of the fiber fabric; and
bonding an elastic member to the fiber layer of the fiber fabric to form a mouse pad.

2. The method as defined in claim 1, wherein a temperature of heating the fiber fabric is equal to or greater than a melting temperature of the fiber fabric to melt fibers of a surface of the fiber fabric to form the flat layer.

3. The method as defined in claim 1, wherein a rolling apparatus is incorporated in heating and pressing the fiber fabric simultaneously.

4. The method as defined in claim 3, wherein the rolling apparatus includes a heating roller and a room temperature roller, and the fiber fabric passes the heating roller and the room temperature roller to be heated and pressed.

5. The method as defined in claim 1, wherein the fiber fabric is heated and then is pressed to form the flat layer.

6. The method as defined in claim 5, wherein the fiber fabric is heated in an oven, and then the fiber fabric is send to a rolling apparatus for pressing.

7. The method as defined in claim 6, wherein the rolling apparatus includes two room temperature rollers, and the fiber fabric passes the room temperature rollers for pressing only.

8. The method as defined in claim 1, wherein a hot press apparatus is incorporated in simultaneously heating and pressing the fiber fabric.

9. The method as defined in claim 8, wherein the hot press apparatus includes a base and a movable hot pressing plate, and the fiber fabric is put on the base to be heated and pressed simultaneously by the hot pressing plate.

10. The method as defined in claim 1, wherein the elastic member is made of rubber.

11. A method of making a mouse pad, comprising the steps of:
preparing an unprinted mouse pad material including an elastic member and a fiber fabric attached on the elastic member;
heating and pressing the fiber fabric of the mouse pad material to form the fiber fabric with a flat layer and a fiber layer; and
printing a pattern on the flat layer of the fiber fabric.

12. The method as defined in claim 11, wherein a temperature of heating the mouse pad material is equal to or greater than a melting temperature of the fiber fabric to melt fibers of a surface of the fiber fabric to form the flat layer.

13. The method as defined in claim 11, wherein a rolling apparatus is incorporated in heating and pressing the fiber fabric simultaneously.

14. The method as defined in claim 13, wherein the rolling apparatus includes a heating roller and a room temperature roller, and the mouse pad material passes the heating roller and the room temperature roller to be heated and pressed.

15. The method as defined in claim 11, wherein the fiber fabric is heated and then is pressed to form the flat layer.

16. The method as defined in claim 15, wherein the mouse pad material is heated in an oven, and then the mouse pad material is send to a rolling apparatus for pressing.

17. The method as defined in claim 16, wherein the rolling apparatus includes two room temperature rollers, and the mouse pad material passes the room temperature rollers for pressing only.

18. The method as defined in claim 11, wherein a hot press apparatus is incorporated in simultaneously heating and pressing the mouse pad material.

19. The method as defined in claim 8, wherein the hot press apparatus includes a base and a movable hot pressing plate, and the mouse pad material is put on the base to heat and press the fiber fabric simultaneously by the hot pressing plate.

20. The method as defined in claim 11, wherein the elastic member is made of rubber.
